(19) United States
(12) Patent Application Publication
(10) Pub. No.: US 2010/0263807 A1
(43) Pub. Date: Oct. 21, 2010

(54) Freestanding modular wall

(76) Inventor: Steven F. Kinder, Dallas County, TX (US)

Correspondence Address: W. THOMAS TIMMONS, 1320 PRUDENTIAL DRIVE, SUITE 208, DALLAS, TX, 75235-4117, US

(21) Appl. No.: 12/386,290

(22) Filed: Apr. 16, 2009

(51) Int. Cl. A47G 5/00; B32B 3/10

(52) U.S. Cl. 160/182; 160/351; 428/195.1

(57) ABSTRACT

A freestanding modular wall according to the present invention includes at least two base members, a vertical post securely attached to each base member, a bottom horizontal bar between each pair of posts, a plurality of substantially rectangular panels, a horizontal bar above each panel or each horizontal row of panels, and a vertical bar between each pair of panels or each vertical column of panels. Each vertical post forms at least one vertical slot for receiving the ends of horizontal bars and the vertical edges of panels, and each vertical bar forms slots on both edges for receiving the vertical edges of panels and the ends of horizontal bars. Likewise, each horizontal bar forms slots along at least one edge for receiving the ends of vertical bars and horizontal edges of the panels. Each panel forms two faces, two vertical edges and two horizontal edges. Each panel is of a substantially standard depth and each panel face is selected from one to three substantially standard sizes. The panels are arranged in horizontal rows or vertical columns or a combination of the two. In a preferred form, the ends of horizontal bars are releasably lockable into the slots formed by the vertical posts or into the slots formed by the vertical bars, and the ends of the vertical bars releasably lockable into the slots formed by the horizontal bars.

### CROSS-REFERENCE TO RELATED APPLICATIONS

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention generally relates to walls, partitions and screens, and in one of its aspects, to freestanding walls, partitions and screens.

2. Description of Related Art

The prior art of walls, partitions and screens is extensive. Normally, in the prior art, the construction, even if modular was designed for a specific use, and it was elaborate and complicated. Typically, the panels themselves included support and attachment structure. Often, panels interlocked.

### BRIEF SUMMARY OF THE INVENTION

A freestanding modular wall according to the present invention for placement on a floor or other support surface, includes the combination of at least two base members for contact with the floor or other support surface, a vertical post securely attached to each base member, a bottom horizontal bar between each pair of posts, near the point where the post attaches to one of the at least two base members, a plurality of substantially rectangular panels, a horizontal bar above each panel or each horizontal row of panels, and a vertical bar between each pair of panels or each vertical column of panels.

Each vertical post forms at least one vertical slot for receiving the ends of horizontal bars and the vertical edges of panels, and each vertical bar forms slots on both edges for receiving the vertical edges of panels and the ends of horizontal bars. Likewise, each horizontal bar forms slots along at least one edge for receiving the ends of vertical bars and horizontal edges of the panels.

Each panel forms two faces, two vertical edges and two horizontal edges. Each panel is of a substantially standard depth and each panel face is selected from one to three substantially standard sizes. The panels are arranged in horizontal rows or vertical columns or a combination of the two.

In a preferred form, the ends of horizontal bars are releasably lockable into the slots formed by the vertical posts or into the slots formed by the vertical bars, and the ends of the vertical bars releasably lockable into the slots formed by the horizontal bars.

In a preferred form, there are only two base members, and each horizontal bar is attached to both vertical posts. This forms horizontal rows of panels. The horizontal sizes of the panel faces are selected from the group stretching between the vertical posts, stretching halfway between the vertical posts, minus the horizontal space taken by the vertical bar separating the panels, and one forth the distance between the vertical posts, minus the space taken by vertical bars between them. The amount of horizontal space taken up by a vertical bar depends of the depth of the slots and how deeply each panel fits into the slot, as well as other factors.

In one preferred form, the freestanding modular wall forms three horizontal rows of panels. The panels are decorative on both faces and chosen from a group including: transparent, translucent, colored translucent, colored opaque, textured, fabric covered, graphic design, wall paper, photographic, marker board and print. It is possible, of course, that other forms of panels could be chosen, but these are ones currently preferred. Typically, panels are constructed from foam board or Gator Board. In the past, such boards have sometimes had a single side with a tacky adhesive covered by release paper. In one arrangement of panels according to the current invention, such board have tacky adhesive on both sides with release paper, so that a decorative covering can easily be placed on both sides of the board by an end user.

These and other objects, advantages and features of this invention will be apparent from the following description taken with reference to the accompanying drawing, wherein is shown a preferred embodiment of the invention.

### BRIEF DESCRIPTION OF THE SEVERAL VIEWS OF THE DRAWING

FIG. 1 is a front right perspective view of a freestanding modular wall according to the present invention;

FIG. 2 is a front right perspective view of an alternative arrangement of a freestanding modular wall according to the present invention;

FIG. 3 is a front left perspective view of a base frame for a freestanding modular wall according to the present invention;

FIG. 4 is a front left perspective view of the base frame of FIG. 3 showing the initial placement of a first row of panels and vertical bars for a freestanding modular wall according to the present invention

FIG. 5 is a front left perspective view of the structure of FIG. 4, showing the positioning of the final panel for the first row of panels and a horizontal bar for keeping the first row of panels in place for a freestanding modular wall according to the present invention;

FIG. 6 is a front left perspective view of the structure of FIG. 5 showing the placement of the second row of panels and a horizontal bar for keeping the second row of panels in place for a freestanding modular wall according to the present invention;

FIG. 7 is a front left perspective view of the structure of FIG. 6 showing the placement of the third row of panels and a horizontal bar for keeping the third row of panels in place for a freestanding modular wall according to the present invention;

FIG. 8 is a sectional view taken along lines 8-8 of FIG. 1;

FIG. 9 is a sectional view taken along lines 9-9 of FIG. 1;

FIG. 10 is a sectional view taken along lines 10-10 of FIG. 1;

FIG. 11 is a detail view showing a typical way of attaching a base member to a support post; and

FIG. 12 is a detail view of a typical locking mechanism for vertical and horizontal bars and support posts.

### DETAILED DESCRIPTION OF THE INVENTION

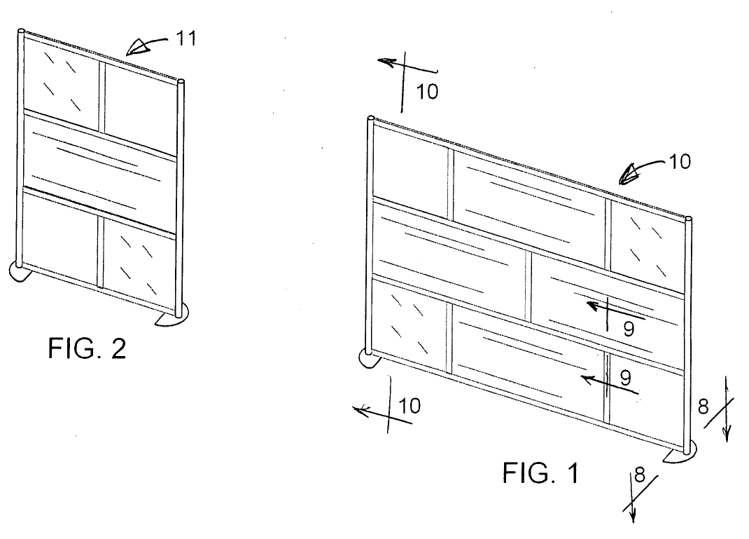

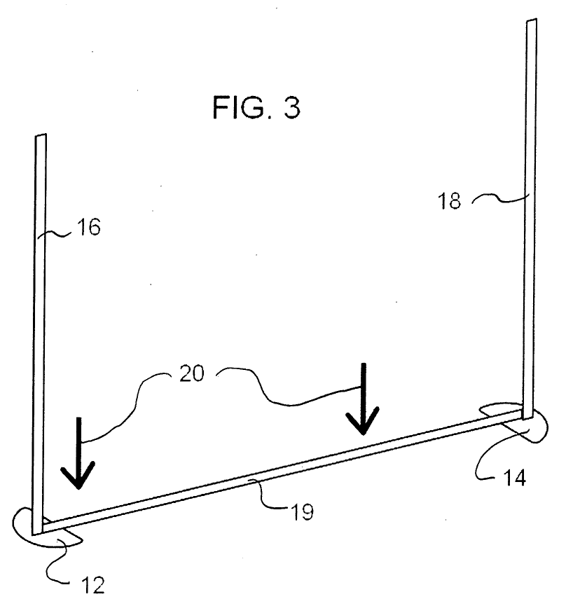

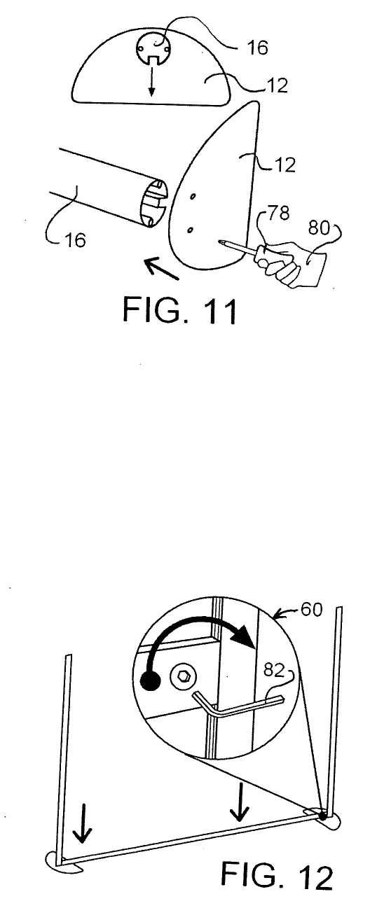

Referring now to the drawing, and in particular to FIG. 1, a freestanding modular wall according to the present invention is referred to generally by reference numeral 10. Referring also to FIG. 2, an alternative arrangement of a freestanding modular wall according to the present invention is referred to generally by reference numeral 11, but there are many different arrangements according to the present invention. Freestanding modular wall 10 is for placement on a floor or other support surface. Referring also to FIG. 3, a freestanding wall according to the present invention includes at least two base members 12 and 14 for contact with the floor or other support surface, a vertical post 16 securely attached to base member 12 and a vertical post 18 securely attached to base member 14. Referring to FIG. 11, a typical way of securing a base member to a post is by screwing the base member into the bottom of the post. Even a screwdriver 78 by hand 80 can adequately secure a base in many cases. A bottom horizontal bar 19 is between each pair of posts and attached to the posts by a releasable locking mechanism, near the point where the post attaches to one of the at least two base members. Referring to FIG. 12, a typical locking mechanism is a locking mechanism 60, of a standard variety, using an Allen wrench 82. A plurality of substantially rectangular panels is arranged in the wall. A horizontal bar is above each panel or each horizontal row of panels, and a vertical bar is between each pair of panels or each vertical column of panels.

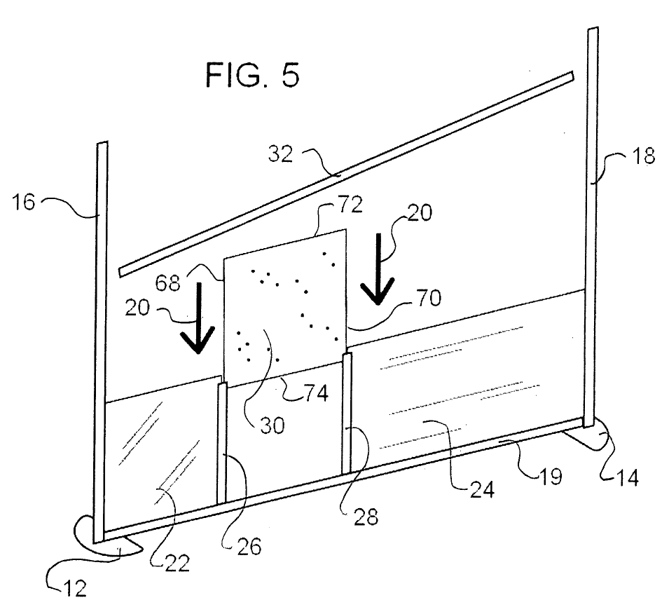

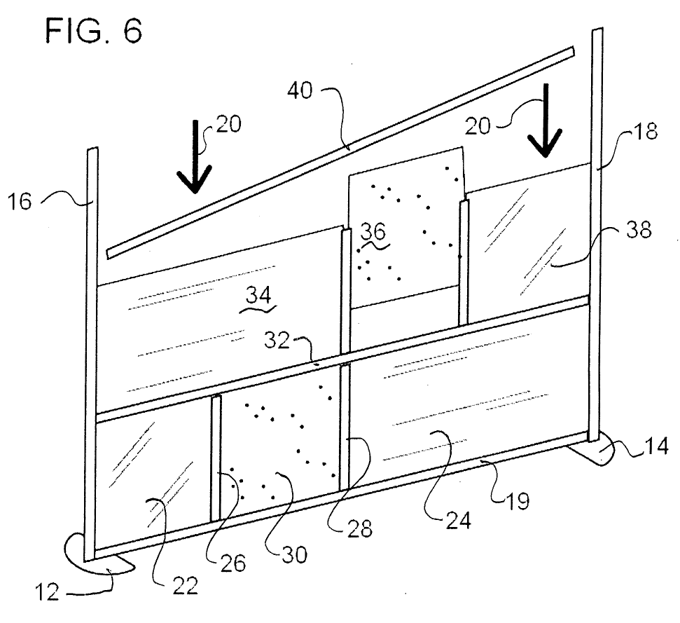

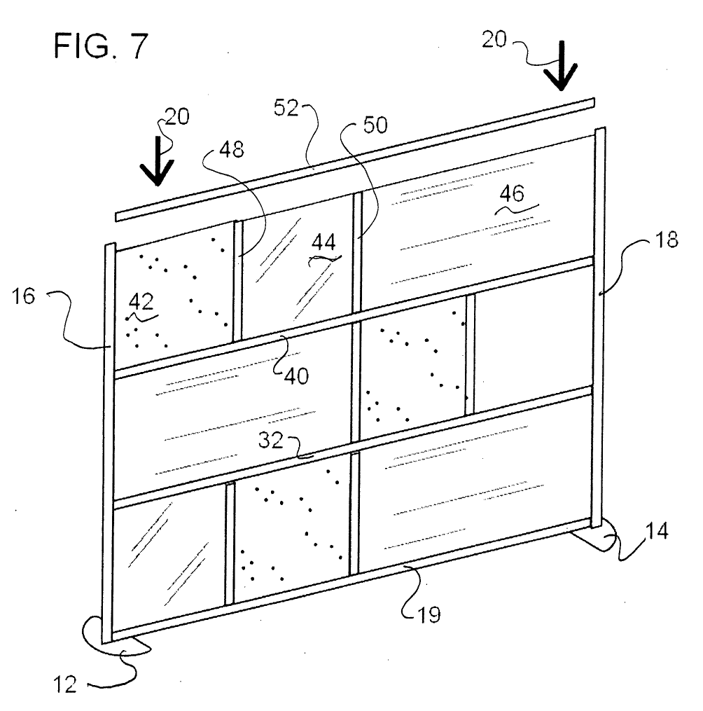

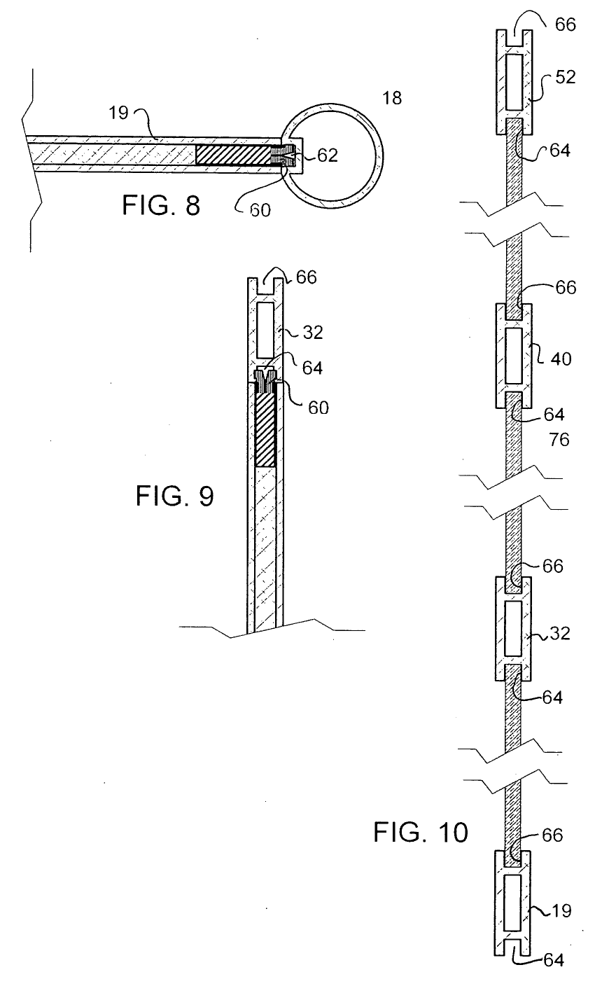

Referring now to FIG. 8, FIG. 9 and FIG. 10, each vertical post 16 and 18 forms at least one vertical slot 62 for receiving the ends of horizontal bars and the vertical edges of panels, and each vertical bar forms slots on both edges for receiving the vertical edges of panels and the ends of horizontal bars. Likewise, referring to FIG. 5, FIG. 6 and FIG. 7 each horizontal bar 19, 32, 40 and 52 forms slots 64 and 66 along at least one edge for receiving the ends of vertical bars and horizontal edges of the panels.

Referring now to FIG. 5, each panel forms two faces, two vertical edges 68 and 70 and two horizontal edges 72 and 74. Each panel is of a substantially standard depth 76 and each panel face is selected from one to three substantially standard sizes. The panels are arranged in horizontal rows or vertical columns or a combination of the two.

In a preferred form, the ends of horizontal bars are releasably lockable into the slots formed by the vertical posts or into the slots formed by the vertical bars, and the ends of the vertical bars releasably lockable into the slots formed by the horizontal bars.

In a preferred form, there are only two base members, and each horizontal bar is attached to both vertical posts. This forms horizontal rows of panels. The horizontal sizes of the panel faces are selected from the group stretching between the vertical posts, stretching halfway between the vertical posts, minus the horizontal space taken by the vertical bar separating the panels, and one forth the distance between the vertical posts, minus the space taken by vertical bars between them. The amount of horizontal space taken up by a vertical bar depends of the depth of the slots and how deeply each panel fits into the slot, as well as other factors.

In one preferred form, the freestanding modular wall forms three horizontal rows of panels. The panels are decorative on both faces and chosen from a group including: transparent, translucent, colored translucent, colored opaque, textured, fabric covered, graphic design, wall paper, photographic, marker board and print. It is possible, of course, that other forms of panels could be chosen, but these are ones currently preferred. Typically, panels are constructed from foam board or Gator Board. In the past, such boards have sometimes had a single side with a tacky adhesive covered by release paper. In one arrangement of panels according to the current invention, such board have tacky adhesive on both sides with release paper, so that a decorative covering can easily be placed on both sides of the board by an end user.

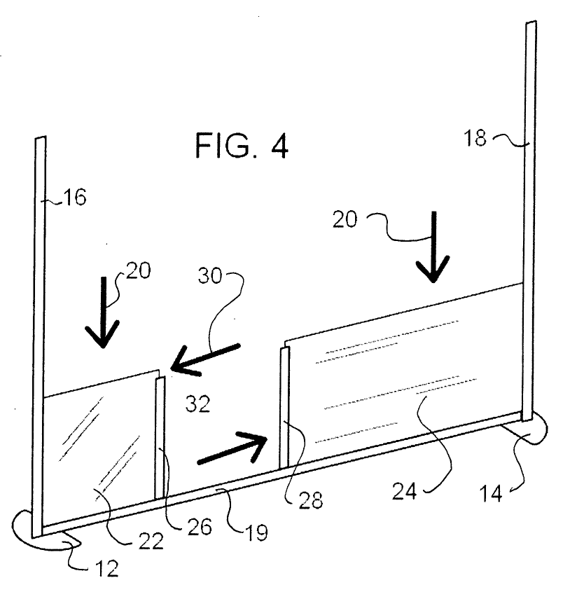

It can thus be seen that the panels simply slide into the various slots, but do not attach. The vertical and horizontal bars attach by a lock mechanism, thus giving the wall its necessary rigidity. Referring to FIGS. 4 and 5, panels 22, 30 and 24 along with vertical bars 26 and 28 form a first row. Panels simply slide into place, so that it is easy to take the wall apart and reassemble it with new or redecorated panels with different panel sizes or rearranged panel sizes. Horizontal bar 32 is placed over the first row so that the top edges of the panels are in slot 64 and vertical bars 26 and 28 are locked into horizontal bar 32. Referring to FIG. 6, the second row is constructed in a manner similar to that of the first row, with panels 34, 36 and 38 fitting into the top slot of horizontal bar 32 and the bottom slot of horizontal bar 40. The vertical posts lock into both horizontal bars. Referring also to FIG. 7, the third row is similarly constructed, with panels 42, 44 and 46 fitting into the top slot of horizontal bar 40 and the bottom slot of horizontal bar 52. Similarly, vertical bars 48 and 50 lock into horizontal bars 40 and 52.

It can also be seen that panels 24, 34 and 46 are approximately half the distance between the posts, allowing for the horizontal space taken up by the vertical members, minus slot distances. Similarly, panels 22, 30, 36, 38, 42 and 44 are approximately one forth of the distance between the posts, allowing for horizontal space taken up by the vertical members, minus the slot distances.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the figures of the accompanying drawings is to be interpreted as illustrative and not in a limiting sense.

[symbol]

1. A freestanding modular wall for placement on a floor or other support surface, comprising in combination:
at least two base members for contact with the floor or other support surface;
a vertical post securely attached to each base member;
a bottom horizontal bar between each pair of posts, near the point where the post attaches to one of the at least two base members;
a plurality of substantially rectangular panels, forming two faces and two vertical edges and two horizontal edges, wherein each panel is of a substantially standard depth and each panel face is one of from one to three substantially standard sizes, and wherein the panels are arranged in horizontal rows or vertical columns or a combination thereof;
a horizontal bar above each panel or each horizontal row of panels; and
a vertical bar between each pair of panels or each vertical column of panels, wherein each vertical post forms at least one vertical slot for receiving the ends of horizontal bars and the vertical edges of panels, and wherein each vertical bar forms slots on both edges for receiving the vertical edges of panels and the ends of horizontal bars, and wherein each horizontal bar forms slots along at least one edge for receiving the ends of vertical bars and horizontal edges of panels.

2. A freestanding modular wall for placement on a floor or other support surface according to claim 1, wherein the ends of horizontal bars are releasably lockable into the slots formed by the vertical posts or into the slots formed by the vertical bars, and wherein the ends of the vertical bars releasably lockable into the slots formed by the horizontal bars.

3. A freestanding modular wall for placement on a floor or other support surface according to claim 2, wherein at least two base members comprises two base members, and wherein each horizontal bar is attached to both vertical posts, forming horizontal rows of panels, and wherein the horizontal sizes of the panel faces are selected from the group stretching between the vertical posts, stretching halfway between the vertical posts, minus the horizontal space taken by the vertical bar separating the panels, and one forth the distance between the vertical posts, minus the space taken by vertical bars between them.

4. A freestanding modular wall for placement on a floor or other support surface according to claim 3, wherein the freestanding modular wall forms three horizontal rows of panels.

5. A freestanding modular wall for placement on a floor or other support surface according to claim 4, wherein the panels are decorative on both faces, and chosen from a group including: transparent, translucent, colored translucent, colored opaque, textured, fabric covered, graphic design, wall paper, photographic, marker board and print.

6. A freestanding modular wall for placement on a floor or other support surface according to claim 1, wherein at least two base members comprises two base members, and wherein each horizontal bar is attached to both vertical posts, forming horizontal rows of panels, and wherein the horizontal sizes of the panel faces are selected from the group stretching between the vertical posts, stretching halfway between the vertical posts, minus the horizontal space taken by the vertical bar separating the panels, and one forth the distance between the vertical posts, minus the space taken by vertical bars between them.

7. A freestanding modular wall for placement on a floor or other support surface according to claim 6, wherein the freestanding modular wall forms three horizontal rows of panels.

8. A freestanding modular wall for placement on a floor or other support surface according to claim 7, wherein the panels are decorative on both faces, and chosen from a group including: transparent, translucent, colored translucent, colored opaque, textured, fabric covered, graphic design, wall paper, photographic, marker board and print.

9. A freestanding modular wall for placement on a floor or other support surface according to claim 1, wherein the freestanding modular wall forms three horizontal rows of panels.

10. A freestanding modular wall for placement on a floor or other support surface according to claim 9, wherein the panels are decorative on both faces, and chosen from a group including: transparent, translucent, colored translucent, colored opaque, textured, fabric covered, graphic design, wall paper, photographic, marker board and print.

11. A freestanding modular wall for placement on a floor or other support surface according to claim 1, wherein the panels are decorative on both faces, and chosen from a group including: transparent, translucent, colored translucent, colored opaque, textured, fabric covered, graphic design, wall paper, photographic, marker board and print.
